(19) United States
(12) Patent Application Publication
(10) Pub. No.: US 2010/0051602 A1
(43) Pub. Date: Mar. 4, 2010

(54) FOOD ROASTER

(75) Inventors: Glenn Beardsley, Hermosa Beach, CA (US); Kenneth H. Davids, Alameda, CA (US)

Correspondence Address: DAVIS WRIGHT TREMAINE LLP/Los Angeles, 865 FIGUEROA STREET, SUITE 2400, LOS ANGELES, CA, 90017-2566, US

(73) Assignee: Green Growth Coffee, Inc., Beverly Hills, CA (US)

(21) Appl. No.: 12/067,707

(22) PCT Filed: Sep. 20, 2006
(86) PCT No.: PCT/US06/36601

§ 371 Date: Feb. 6, 2009

Related U.S. Application Data
(60) Provisional application No. 60/718,977, filed on Sep. 21, 2005.
(60) Provisional application No. 60/726,426, filed on Oct. 13, 2005.

(51) Int. Cl. A47J 37/00

(52) U.S. Cl. 219/429

(57) ABSTRACT

The present invention provides for a food roaster, a method of roasting food and a kit for roasting food. The food roaster generally comprises a base (118); a motor (109) and fan assembly (107) positioned within the base (118); a hearing element (108) positioned within the base (118) and in gaseous communication with the motor (109) and fan assembly (107); a roasting chamber (103) removably attached to a top portion of the base (118); a support tower (116) mechanically affixed to the base; and a filter (101 A) to remove smoke expelled from the roasting chamber (103), the filter (101 A) positioned within an upper portion of the support tower (116), wherein the base (118), the motor (109) and fan assembly (107), the heating element (108), the roasting chamber (103), and the filter (101A) are configured along a substantially unitary vertical axis.

### FIELD OF INVENTION

Embodiments of the present invention relate to food roasters, methods of roasting food and kits for roasting food; particularly to coffee bean roasters, methods of roasting coffee beans and kits for roasting coffee beans.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Home roasting may provide control over the origin of the beans and the roasting method. Home roasters may have access to specialty suppliers for quality beans. These beans may cost more than the beans typically used by commercial roasters, but may have favorable characteristics sought by coffee connoisseurs.

Quality in home roasted coffee is often associated with the source of raw (“green”) beans used and the freshness factor. Indeed, coffee may lose 25% of its flavor in the first 24 hours after roasting.

Additionally, raw coffee beans contain a high amount of anti-oxidants. Roasted coffee may lose most of its anti-oxidant content within three days. Polyphenolic compounds called flavonoids are particularly widespread in plants and important in disease protection. Green coffee beans may contain about 1,000 antioxidants, and the brewing process may add 300 more.

As such, home roasted coffee may provide the consumer with fresh, flavorful coffee with higher anti-oxidant contents. Home roasting may also present a cost savings to the consumer.

However, over-roasting, roasting too quickly, and/or roasting at too high of a temperature may burn the coffee beans and under-roasting, roasting too slowly and/or roasting at too low of a temperature may deplete the flavor of the bean. As such, there is a need in the art for a coffee bean roaster to enable home roasting, variable control of the roasting process and provide appropriate roasting cycles.

### SUMMARY OF THE INVENTION

The following embodiments and aspects thereof are described and illustrated in conjunction with apparatuses, methods and kits are meant to be exemplary and illustrative, not limiting in scope.

Embodiments of the present invention provide for food roasters, methods of roasting food and kits for roasting food.

Various embodiments of the present invention provide for food roasters. In one embodiment, the food roaster comprises a base; a motor and fan assembly positioned within the base; a first heating element positioned within the base and in gaseous communication with the motor and fan assembly; a roasting chamber removably attached to a top portion of the base; a support tower mechanically affixed to the base; and a filter to remove smoke expelled from the roasting chamber, the filter positioned within an upper portion of the support tower, wherein the base, the motor and fan assembly, the heating element, the roasting chamber, and the filter are configured along a substantially unitary vertical axis.

In one embodiment, the food roaster may be adapted to roast coffee beans.

In another embodiment, the roasting chamber of the food roaster may comprise a handle. In another embodiment, the roasting chamber may comprise an agitator in mechanical communication with a portion of the roasting chamber. In another embodiment, the roasting chamber may comprise a thermometer configured to measure the temperature of a food or the temperature of the air in the roasting chamber. In a particular embodiment, the thermometer may be a thermocouple. In another embodiment, the roasting chamber may comprise ribs on the inside wall to assist in mixing a food and managing the food flow. In another embodiment, the roasting chamber may comprise at least one tab configured to interact with at least one corresponding mechanical element on the base to removably attach the roasting chamber to the base.

In another embodiment, the filter may comprise a catalyst and a second heating element.

In another embodiment, the food roaster may further comprise a drive gear connected to the motor and the agitator.

In another embodiment, the food roaster may further comprise a pulley and drive belt connected to the motor; and a reduction gear set connected to the pulley and drive belt.

In another embodiment, the food roaster may further comprise a reduction gear set connected to the motor.

In another embodiment, the food roaster may further comprise a chaff collector removably attached to the filter. In one embodiment, the chaff collector may comprise an annular ring to collect chaff.

In another embodiment, the food roaster may further comprise a screen removably attached to the chaff collector.

In another embodiment, the food roaster may further comprise a control panel positioned on the support tower. In one embodiment, the support tower may further comprise a lower portion and a hinge connecting the lower portion of the support tower to the upper portion of the support tower.

In another embodiment, the base of the food roaster may further comprise an air inlet.

In another embodiment, the food roaster may further comprise an electrical cord to provide electrical communication between the food roaster and an external power supply.

In another embodiment, the upper portion of the support tower may further comprise a locking tab configured to interact with a corresponding element on the roasting chamber to secure the upper portion of the support tower to the roasting chamber.

Other embodiments of the present invention provide for methods of roasting food. In one embodiment, a method of roasting food comprises providing raw food; placing the raw food in a food roaster, comprising a base, a motor and fan assembly positioned within the base, a first heating element positioned within the base and in gaseous communication with the motor and fan assembly, a roasting chamber removably attached to a top portion of the base, a support tower mechanically affixed to the base, and a filter to remove smoke expelled from the roasting chamber, the filter positioned within an upper portion of the support tower, wherein the base, the motor and fan assembly, the heating element, the roasting chamber, and the filter are configured along a substantially unitary vertical axis, and wherein the food is placed into the roasting chamber; operating the food roaster to provide heated airflow into the roasting chamber and to allow exhaust from the roasting chamber to flow through the filter prior to exiting the food roaster; and cooling the food.

In another embodiment, the food roaster utilized by the method may further comprise an agitator in mechanical communication with a portion of the roasting chamber, and operating the food roaster may further comprise operating the food roaster to stir the raw food with the agitator.

In another embodiment, the filter of the food roaster utilized by the method may further comprise a catalyst and a second heating element, and operating the food roaster may further comprise heating the exhaust in the filter prior to allowing the exhaust to exit the food roaster.

In another embodiment, the method may further comprise allowing the food to be heated to from about 220° C. to about 250° C.

In another embodiment, the raw food roasted by the method may comprise raw coffee beans.

Additional embodiments of the present invention provide for kits for roasting food. The kits may comprise a food roaster, comprising a base, a motor and fan assembly positioned within the base, a first heating element positioned within the base and in gaseous communication with the motor and fan assembly, a roasting chamber removably attached to a top portion of the base, a support tower mechanically affixed to the base, and a filter to remove smoke expelled from the roasting chamber, the filter positioned within an upper portion of the support tower, wherein the base, the motor and fan assembly, the heating element, the roasting chamber, and the filter are configured along a substantially unitary vertical axis; and instructions for using the food roaster to roast a raw food. In one embodiment, the raw food roasted by the kit may comprise raw coffee beans.

Other features and advantages of the invention will become apparent from the following detailed description, taken in conjunction with the accompanying drawings, which illustrate, by way of example, various features of embodiments of the invention.

### BRIEF DESCRIPTION OF THE FIGURES

Exemplary embodiments of the present invention are illustrated in FIGS. 1-5. It is intended that the embodiments and figures disclosed herein are considered illustrative rather than restrictive.

FIGS. 1A and 1B depict a side and top view, respectively, of a coffee bean roaster in accordance with various embodiments of the present invention.

FIG. 2 depicts a coffee bean roaster with the upper section lifted in accordance with an embodiment of the present invention.

FIG. 3 depicts a coffee bean roaster with the roasting chamber removed in accordance with an embodiment of the present invention.

FIG. 4 depicts various components of a roasting chamber in accordance with an embodiment of the present invention.

FIGS. 5A and 5B depict a coffee bean roaster with the upper section lowered and lifted, respectively, in accordance with various embodiments of the present invention.

### DESCRIPTION OF THE INVENTION

Unless defined otherwise, technical and scientific terms used herein have the same meaning as commonly understood by one of ordinary skill in the art to which this invention belongs. One skilled in the art will recognize many methods and materials similar or equivalent to those described herein, which could be used in the practice of the present invention. Indeed, the present invention is in no way limited to the methods and materials described.

“First crack” as used herein refers to the cracking sound that is heard when coffee beans reach about 160° C.

“Second crack” as used herein refers to the cracking sound that is heard after the cessation or substantial cessation of the first crack.

“Substantially unitary vertical axis” as used herein with respect to components of the food roaster refers to having the most or all of the components of the food roaster positioned atop of each other along the vertical axis of the food roaster. It is substantially unitary because design considerations may result in a product in which the components are not exactly unitary, but still having a generally linear orientation along a particular vertical axis.

The present invention provides for food roasters, methods of roasting food and kits for roasting food.

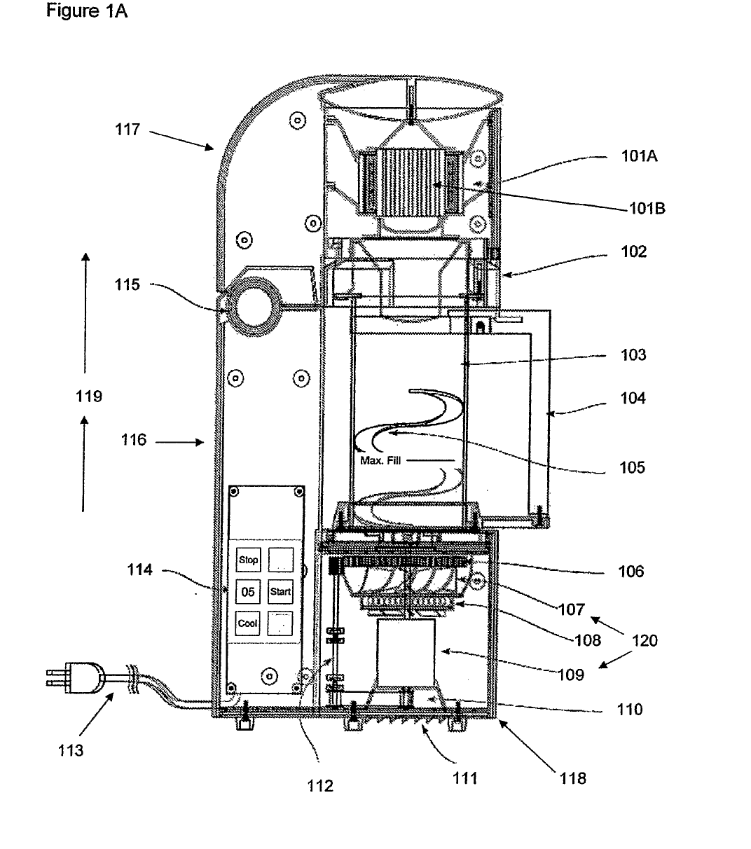

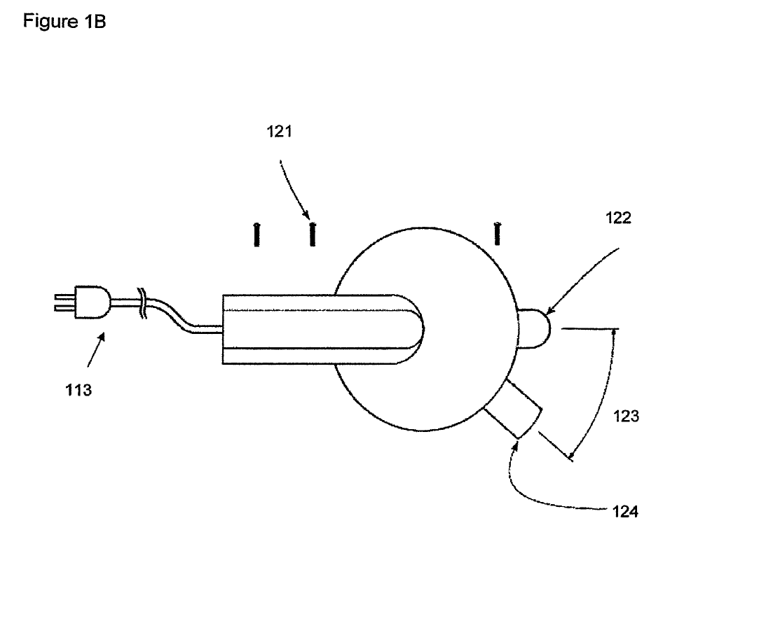

FIG. 1 depicts one embodiment of the present invention. As shown in FIG. 1A, the roaster may comprise one or more of the following: a filter 101A, a chaff collector 102, a roasting chamber 103, a handle 104, an agitator 105, a drive gear for the agitator 106, a motor and fan assembly 120 comprising a fan 107 and a motor 109, a heating element 108, a pulley and drive belt 110, an air inlet 111, a reduction gear set 112, an electrical cord 113, a control panel 114, a hinge 115, a lower support tower 116, an upper support tower 117 and a base 118. In one embodiment, two or more components of the food roaster may be configured along a substantially unitary vertical axis. This arrangement may have benefits during the production of the food roaster; for example, reduce production cost and/or increase the efficacy of production. This arrangement may also be beneficial to the user. The sleekness of the design may use less counter space and/or be more aesthetically pleasing.

### Support Tower

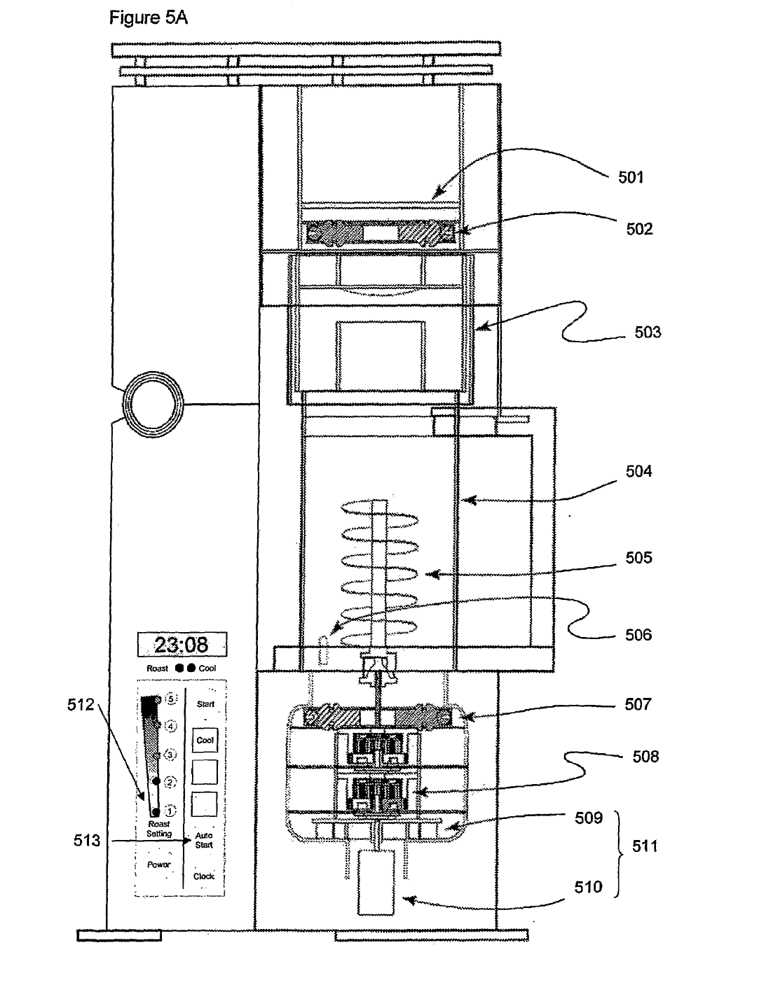

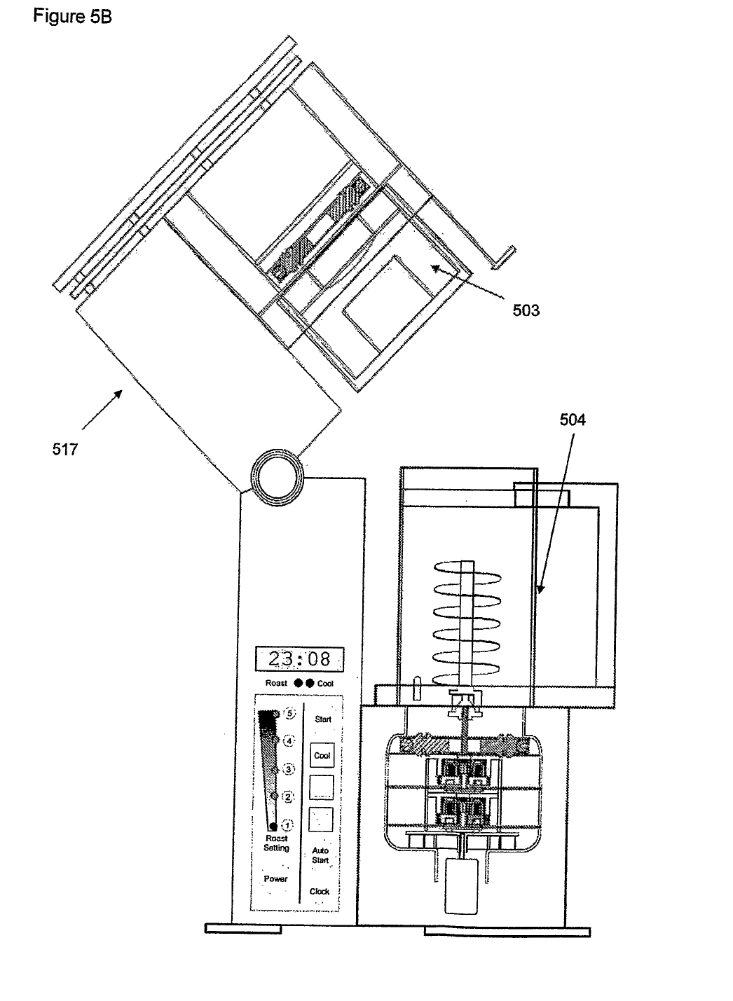

In one embodiment, as depicted in FIG. 1A, a support tower for the present invention may comprise a lower support tower 116 and an upper support tower 117. A lower support tower 116 may comprise a control panel 114 with electronic controls and displays; for example, printed circuit board (PCB), LCD screen, LED lights, buttons; and an electrical cord 113 to provide electrical communication between the food roaster and an external power supply. The user may set the roasting time and start the roaster with this control panel 114. In an alternative embodiment, the user may set the type of roast 514 (e.g., lightest to darkest) (see FIG. 5A). The user may also stop the roasting process from this control panel 114. The lower support tower 116 may be integral with the base 118 of the roaster. The roast cycle may be programmed to start at a predetermined time. For example, an auto start button 515 may be utilized to program the roaster to start the roast cycle at a later time (see FIG. 5A). This may be beneficial to the user; for example, allowing the user to program the roaster in the evening and have freshly roasting coffee beans in the morning.

LED lights may be utilized to indicate the progress of the roasting cycle; for example, a red LED light may indicate that the roasting cycle is in progress and a green LED light may indicate that the cooling cycle is in progress. Other types of indicia may alternatively be utilized to indicate the progress of the roasting cycle.

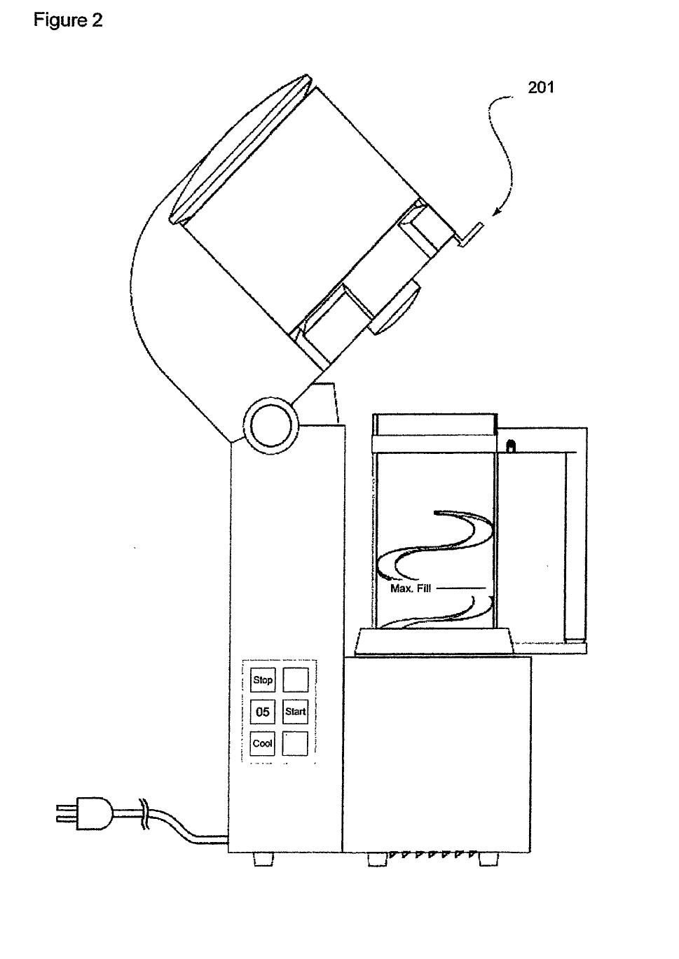

An upper support tower 117 may be connected to the lower support tower 116 with a hinge 115. The upper support tower 117 may comprise a filter 101A to filter the smoke generated during a roasting cycle, and a chaff collector 102. In one embodiment, the upper support tower 117 may rotate any number of degrees to facilitate removal of the roasting chamber 103 and the chaff collector 102. In one particular embodiment, as shown in FIG. 2, the upper support tower is rotated to about 45° 201. The upper support tower 117 may contain a micro-switch, or any other sensing device, which may sense the closure of the upper support tower 117. The upper support tower 117 may have a spring which prevents the micro-switch from closing unless the upper support tower 117 is properly latched onto the roasting chamber. A control system may be configured to not allow the roaster to operate without the upper support tower 117 being properly latched.

FIG. 1B depicts a top view of a roaster in accordance with an embodiment of the present invention. The upper and lower sections of the roaster may be assembled with screws 121 or any other mechanical fastening elements. The upper section may have a locking tab 122. A roasting chamber may rotate 123 into open and closed positions 124. In one embodiment, the closed position may be any number of degrees from the center of the roaster. In one embodiment, when a handle of the roasting chamber is about 40° from the center of the roaster, the roasting chamber is in a closed position.

### The Base

In one embodiment, a base 118 may be an integral part of the lower support tower. The base 118 of the roaster may comprise a motor and fan assembly 120 comprising a motor 109 and a fan 107, and a heating element 108 in gaseous communication with the motor and fan assembly 120. The heating element 108 may heat the air that is blown into the roasting chamber 103 by the fan 107. In one embodiment, the hot air may be blown into and through the roasting chamber 103 in a vertical direction 119. The temperature of the hot air may be a temperature that is sufficient for roasting the food. In various embodiments, the temperature of the air may be sufficient to roast coffee beans. Appropriate temperatures will be readily recognized by those skilled in the art. In one embodiment, the hot air may be from about 150° C. to about 300° C. In another embodiment, the hot air may be from about 190° C. to about 250° C. In another embodiment, the hot air may be from about 190° C. to about 200° C. The air may be blown at any appropriate speed. In one embodiment, the air flow may be about 1.6 m/s to about 2.5 m/s. In another embodiment, the air flow may be about 1.8 m/s to about 2.0 m/s. The fan 107 and the heating element 108 in the base may be configured as shown in FIG. 1A with the fan 107 above the heating element 108. Alternatively, the fan 107 and the heating element 108 may be configured with the fan 107 below the heating element 108. The roaster may comprise a thermometer (not shown FIG. 1) to measure the air temperature before it exits the lower support tower 116. This may allow for regulating the heating element 108 to maintain a consistent roasting temperature. In one embodiment, the thermometer may be a thermocouple 506 to sense the temperature of the food. (See FIG. 5A.) In one embodiment, the roaster may include a regulation circuitry that regulates the temperature such that the desired temperature or temperature range is achieved.

The base may also comprise a drive gear 106 that mechanically engages with the bottom of the roasting chamber 103 to rotate an agitator 104 at a speed slower than the speed of the motor 109. In one embodiment, the speed of the agitator 104 may be significantly slower than the speed of the motor 109. In one embodiment the speed of the agitator 104 may spin at a speed that is about 5% to about 20% of the speed of the motor 109. In another embodiment, the agitator 104 may spin at a speed that is about 10% to about 15% of the speed of the motor 109. In another embodiment, the agitator 104 may spin at a speed that is about 12% of the speed of the motor 109. In another embodiment, the drive gear 106 may rotate an agitator 104 at a speed that is faster than the speed of the motor 109. In an additional embodiment, one or more reduction gear sets 112 may be included such that the agitator 105 may spin at a speed slower than the speed of the motor 109. In one embodiment, the reduction gear set 112 may be configured to perform a reduction of about 1:5 to about 1:10. In another embodiment, the reduction gear set 112 may be configured to perform a reduction of about 1:8. The reduction gear set 112 may be connected to a pulley and drive belt 110 that may be connected to the motor 109. In an alternative embodiment, as depicted in FIG. 5A, the reduction gear set 508 may be directly connected to the motor 510. The reduction gear set 112 may also serve as a differential. In situations wherein the agitator fails to properly spin (e.g., it becomes stuck or jammed), the differential allows the motor 109 and/or the fan 107 to freely spin. This embodiment may assist in preventing the possibility of electrical or thermal overload which otherwise may pose a fire hazard.

Air may be drawn into the base 118 through an air inlet 111, which may have slots in the bottom panel and/or slots in the vertical side surface. In another embodiment, the interface between the base 118 and the roasting chamber 103 may have a screen (not shown) or perforated panel (not shown) to allow air to pass but prevent debris from falling into or from being drawn into the base.

### Roasting Chamber

In one embodiment, as depicted in FIG. 1A, above the base 118 is the roasting chamber 103. The roasting chamber 103 holds the food (e.g., coffee beans, grains, nuts, etc.) during the roasting process, which may include a cooling period.

The roasting chamber 103 may be any appropriate size. In one embodiment, the roasting chamber 103 may be a size suitable for a home roaster. In another embodiment, the roasting chamber 103 may be a larger size that is suitable for use in a coffee shop or café. In one particular embodiment, the roasting chamber 103 may hold up to about 250 ml of food. In another embodiment, the roasting chamber 103 may hold up to about 200 ml of food. In another embodiment, the roasting chamber 103 may hold up to about 150 ml of food. In another embodiment, the roasting chamber 103 may hold up to about 135 ml of food. One skilled in the art will also recognize and be able to configure various components of the roaster to accommodate the size of the roasting chamber 103.

The roasting chamber 103 may be any suitable shape. In one embodiment, the roasting chamber 103 may be cylindrical. In another embodiment, the roasting chamber 103 may be a shape that permits proper mixing of the food (e.g., coffee beans). In another embodiment, the shape of the roasting chamber 103 may be dependent on the shape of an agitator 105 to allow proper mixing of the food and/or proper management of the flow of the food.

Proper mixing and/or proper flow of the food may be obtained by laminar or turbulent movement of the food. The laminar movement may comprise vertical bands of food around the circumference of the roasting chamber with alternating bands moving up and down, and with the food in the center being rotated and lifted by the agitator. The bands may be about 15 mm wide. In another embodiment, the movement may be laminar with pockets of turbulence.

In another embodiment, the roasting chamber 103 may have ribs on the inside wall to assist in mixing the food or managing the food flow. In one embodiment, the ribs may be vertical. In another embodiment, the ribs may be horizontal. In additional embodiments, the ribs may be diagonal.

The roasting chamber 103 may contain an agitator 105 to stir, mix and/or manage the flow of food during roasting, although not required. In one embodiment, the agitator 105 may be a mechanical agitator. In another embodiment, the method of stirring the food may be performed by using air to lift and circulate the food. Stirring of the food allows for even heating of the food; otherwise, the food at the bottom of the roasting chamber 103 may be cooked more than the food at the top of the pile. Managing the flow of the food may also allow for proper mixing of the food. The roasting chamber 103 may be made of any appropriate material that can withstand the heat during a roasting cycle. In one embodiment, the roasting chamber 103 may be made of high temperature glass. In other embodiments, the roasting chamber 103 may be made of material that is metal, composite, ceramic, or combinations thereof.

The roasting chamber may also contain a thermocouple 506 to sense the temperature of the food. (See FIG. 5A.) The thermocouple 506 may also be linked to a circuitry system to monitor and/or respond to the temperature of the food. For example, the circuitry system may regulate the heating element 502 to achieve a specified food temperature. The circuitry system may also be used to turn off the roasting process when the food reaches a specified temperature.

Hot air may pass vertically through the roasting chamber 103, roasting the food, and may exit at the top where it may enter the chaff collector 102.

The roasting chamber 103 may further comprise a handle 104 for the operator to hold the roasting chamber 103 for removal from the roaster and transfer of the food. For example, the operator may transfer roasted food (e.g., roasted coffee beans) to a grinder or storage container. The handle may comprise a tab to latch the upper portion of the roaster in place during the roasting process.

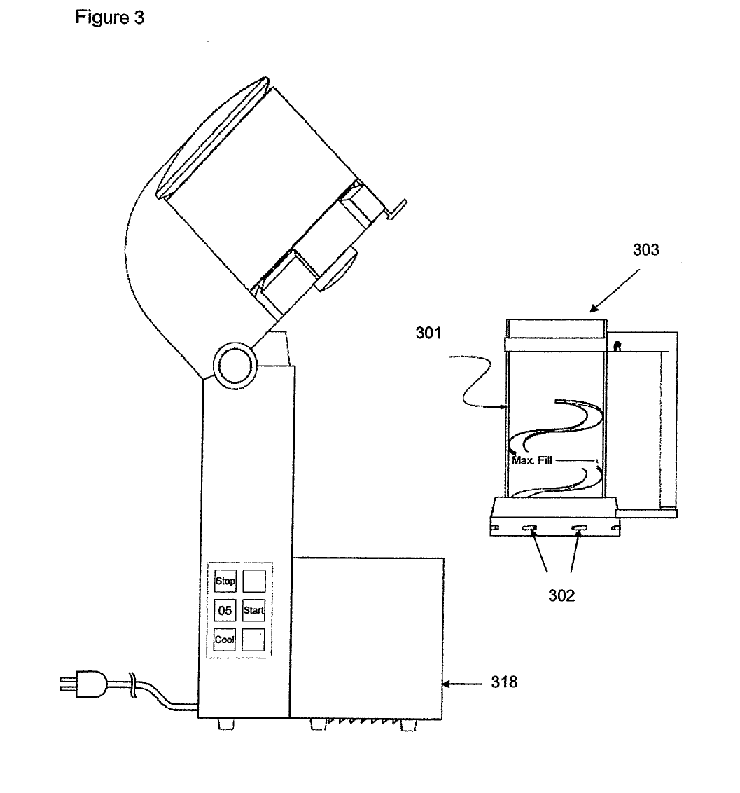

In another embodiment, as shown in FIG. 3, the roasting chamber 303 may be removably attached to the base 318 when in use by one or more tabs 302 configured to interact with one or more corresponding mechanical elements on the base. The roasting chamber 303 may be rotated a few degrees or more for removal 301 from the base 318. In one embodiment, the roasting chamber 303 may be rotated about 45° and lifted for removal from the base 318.

In another embodiment, the bottom of the roasting chamber may have a screen (not shown) or a perforated panel (not shown) to allow air to pass, but keeps the food in the roasting chamber.

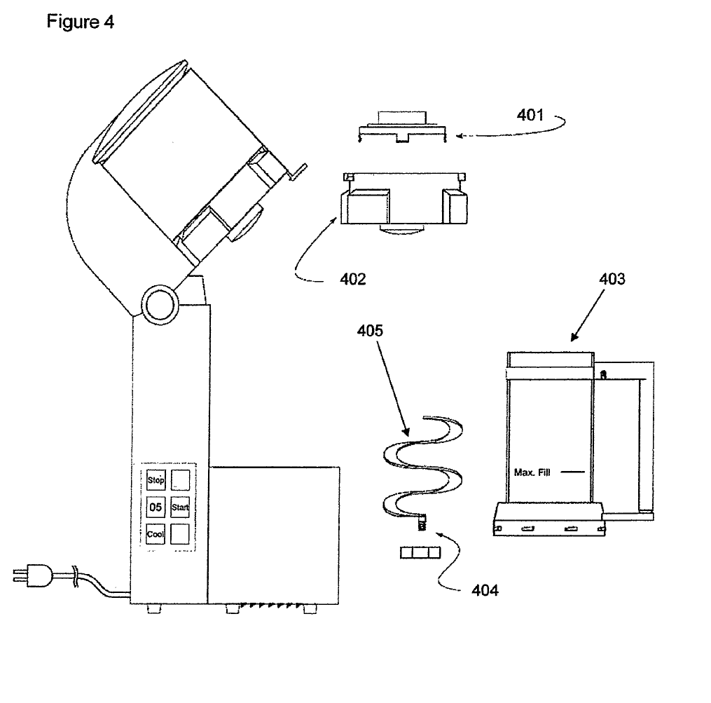

In one embodiment, the agitator 105 may be attached to a bottom portion of the roasting chamber 103. In one embodiment, the bottom portion of the roasting chamber may be removed from the roasting chamber 103 (not shown). In another embodiment, as shown in FIG. 4, the agitator 405 may be removably attached to a bottom portion of the roasting chamber 403. In an alternative embodiment, the agitator may be removably attached to a top portion of the roasting chamber. Removal of the agitator 405 may allow one to clean the agitator 405 and/or the roasting chamber 403. In one embodiment, the agitator 405 may be attached or removed from the roasting chamber 403 by screwing or unscrewing it 404 from the roasting chamber 403. In alternative embodiments, the agitator 405 may be attached or removed from the roasting chamber 403 by any other manner known in the art.

### Chaff Collector

In one embodiment, as depicted in FIG. 1A, above the roasting chamber 103 may be a chaff collector 102. The volume and velocity of air being blown through the roasting chamber 103 may be sufficient to carry the chaff vertically out of the roasting chamber 103 and into the chaff collector 102. In one embodiment, the chaff collector 102 may comprise a central cup with openings for air flow around the periphery. As the air flow containing the chaff moves from the periphery of the chaff collector to the center to pass into the filter 101A, the air flow may lose much of its ability to exert a vertical force on the chaff. In another embodiment, the chaff collector 102 may comprise an annular ring with an opening for air to flow through the center (not shown). In this embodiment, air may flow through the center of the chaff collector and the chaff may be collected in the annular ring.

In one embodiment, as depicted in FIG. 4, a removable screen 401 may sit atop the chaff collector 402. The chaff, unable to pass through the screen, may fall into a collector cup. The chaff collector 402 may be removably attached to the bottom of the filter. In another embodiment, the chaff collector 402 may be rotated by any number of degrees to remove it for cleaning. After removal, the screen 401 may be removed and the chaff may be unloaded for disposal. The screen 401 may be a simple press fit screen onto the top of the chaff collector 402 with a small tab for the user to hold to facilitate removal, although other mechanical securing devices may also be used.

In another embodiment, a micro-switch may be used to sense the presence of the chaff collector 402 in the roaster. The control system may be configured such to not allow the roaster to operate without the chaff collector in place.

### Smoke Filter

In another embodiment, as depicted in FIG. 1A, the upper most section of the roaster may be a filter 101A to remove the smoke generated during the roasting process. The filter 101A may be an integral part of the upper support tower 117. The smoke filter 101A may comprise a filter apparatus 101B for removal of smoke generated in the roasting process. One embodiment, the filter apparatus 101B may comprise a charcoal filter. Another embodiment, the filter apparatus 101B may comprise a catalytic filter. If a catalytic filter is used, a heating element 502 may be used to heat the air in the catalyst 501 to facilitate the catalytic process. (See FIG. 5.) The catalyst 501 may be any appropriate catalyst and may be readily determined by one of skill in the art. In one embodiment, the catalyst 501 may be similar to or the same as those typically used in self-cleaning ovens. In another embodiment, the catalyst 501 may be a precious metal coated on a substrate. In one embodiment, the precious metal may be platinum. In one embodiment, the substrate may be ceramic. In other embodiment, the substrate may be steel or stainless steel. The air may be heated to a temperature sufficient to facilitate the catalytic process. One skilled in the art will be able to readily determine the appropriate temperature. In one embodiment, the air may be heated to from about 400° C. to about 425° C. In a particular embodiment, the air may be heat to about 400° C. The air may pass vertically through the filter 101A and exit the roaster through a slot at the top of the roaster. In another embodiment, the slot may be along the vertical edge of the filter 101A. This embodiment may prevent debris from falling into the roasting chamber 103.

### Roasting Process

Coffee taste is subjective but a bad cup of coffee is usually readily apparent to a consumer. At 400° F., sugars and carbohydrates inside the green bean caramelize in pyrolysis which creates over 800 volatile, water soluble, flavor components (called coffee oils) giving a cup of coffee its taste. The degree of roast is a function of the internal temperature achieved by the bean during roasting. A temperature of about 220° C. to about 230° C. may generate a light roast. A temperature of about 245° C. to about 250° C. may generate a dark roast.

The way in which coffee is roasted can have a profound effect on its taste. Coffee beans roasted quickly at too high a temperature may scorch the exterior of the bean. Coffee beans roasted too slowly at too low a temperature may deplete the bean of its flavor.

Generally, a roasting process may include six phases. (1) Drying Cycle: This is the first phase of the roasting process, when the temperature of the beans rises to about 100° C. Also in this phase, the beans change from a bright green color to a pale yellow. (2) First Crack: When the beans reach 160° C., complex chemical reactions begin to occur causing a cracking sound. (3) Roast Initiation: The beans swell to about 140-160% of their initial size. Elements within the beans begin to caramelize, giving the beans their brown color. (4) Pause: In this phase, the audible cracking ceases, but the chemical reactions continue. The time of this silence may depend on the amount of heat applied by the roaster. (5) Second Crack: The progressive dehydration of the beans makes them brittle. As a result, more cracking can be heard. It is at this stage that elements in the bean begin to carbonize, producing the burnt characteristics of extremely dark roasts. (6) Stopping the Roast: Once the optimal amount of roasting time has elapsed, the beans are cooled quickly. This is usually accomplished by introducing large amounts of cool air or water.

In one embodiment, the roasting process performed by the present invention may be a “fast roast” process. The air entering the bottom of the roasting chamber may be at any suitable temperature to roast the food, including but not limited to coffee beans, grains and nuts. Appropriate temperatures will be readily recognized by those skilled in the art. In one embodiment, the hot air may be from about 150° C. to about 300° C. In another embodiment, the hot air may be from about 190° C. to about 250° C. In another embodiment, the hot air may be from about 190° C. to about 200° C. The air may be blown at any appropriate speed. In one embodiment, the air flow may be about 1.6 m/s to about 2.5 m/s. In another embodiment, the air flow may be about 1.8 m/s to about 2.0 m/s. This may generate a high rate of heat transfer to the food. For roasting coffee beans, the first crack may occur between about 100 and about 180 seconds. The second crack may occur between about 80 and about 120 seconds after the first crack.

In one embodiment, the operator may set the roasting time. Typically this may be from about 3 to about 6 minutes. In one embodiment, the roaster may have a maximum roasting time of up to about 7 minutes. Alternatively, the roasting time may be between about 10 and about 15 minutes and may have a maximum roasting time of up to about 15 minutes. When the roasting process is finished, the roaster may automatically start a cooling period. The cooling period may be from about 3 minutes to about 5 minutes. The cooling period comprises turning off the heating element and continuing to run the fan and bean agitator. For coffee beans the temperature of the beans may be less than about 75° C. within about two minutes of the start of the cooling cycle. In an alternate embodiment, the cooling period may include a sufficient amount of time for not only the food, but also the roaster itself to cool; for instance, about a 5 minute cooling period. This may impart beneficial safety characteristics to the device.

In an alternative embodiment, the roast cycle may be based on the temperature amongst the food in the roasting chamber. A temperature probe (e.g., thermocouple) may be used in the roasting chamber to measure the temperature of the food and when the temperature reaches a predetermined level, the roast cycle may end. In one embodiment, a light roast may be achieved by roasting the coffee bean to an internal bean temperature of from about 220° C. to about 230° C. In one embodiment, a dark roast may be achieved by roasting the coffee bean to an internal bean temperature of from about 245° C. to about 250° C. In another embodiment, intermediate roasts may be achieved by roasting the coffee bean to an internal bean temperature between about 220° C. to about 250° C.; for example, temperatures of 230, 234, 238, 242, 246, and 250° C. may be used.

In another embodiment, the operator may choose the type of roast (i.e., lightness to darkness). One or more settings for the type of roast, which corresponds to the temperature (e.g., a darker roast will correspond to a higher temperature), may be available to the operator.

### Roasting Kits

The present invention is also directed to kits for roasting food. The kit is an assemblage of materials or components, including the inventive food roaster. Thus, in some embodiments the kit contains a food roaster as described above.

The exact nature of the components configured in the inventive kit depends on its intended purpose. For example, some embodiments are configured for the purpose of roasting coffee beans. Other embodiments are configured for the purpose of roasting other food items, including but not limited to grains and nuts.

Instructions for use may be included in the kit. “Instructions for use” typically include a tangible expression describing the technique to be employed in using the components of the kit to roast food. Instructions for use may include but are not limited to instructions for programming the food roaster, instructions for selecting temperature settings, instructions for selecting roast setting, instructions for selecting cooling cycle, instructions for detaching the chaff collector and/or its screen, instructions for detaching the roasting chamber, instruction for detaching the agitator, and instructions for cleaning components of the food roaster. Optionally, the kit also contains other useful components, such as, measuring tools, raw food (e.g., coffee, grains, nuts, etc.) storage containers, coffee filters for brewing coffee and other useful items as will be readily recognized by those of skill in the art.

The materials or components assembled in the kit can be provided to the user stored in any convenient and suitable ways that preserve their operability and utility. The components are typically contained in suitable packaging material(s). As employed herein, the phrase “packaging material” refers to one or more physical structures used to house the contents of the kit, such as the food roaster described herein. The packaging materials employed in the kit are those customarily utilized in small kitchen appliances. As used herein, the term “package” refers to a suitable material such as glass, plastic, paper, cardboard, foil, and the like, capable of holding the individual kit components. The packaging material generally has an external label which indicates the contents and/or purpose of the kit and/or its components.

### EXAMPLE

The following example is provided to better illustrate the claimed invention and is not to be interpreted as limiting the scope of the invention. To the extent that specific materials are mentioned, it is merely for purposes of illustration and is not intended to limit the invention. One skilled in the art may develop equivalent means without the exercise of inventive capacity and without departing from the scope of the invention.

### Example 1

In one embodiment, as depicted in FIG. 5A, a coffee bean roaster may comprise a catalyst 501, a heating element 502, a chaff collector 503, a roasting chamber 504, a bean agitator 505, a thermocouple 506, a heating element, 507, a reduction gear and/or differential 508, a motor and fan assembly 511 comprising a fan 509 and a motor 510. As shown in FIG. 5B, the upper support tower 517 of the coffee bean roaster may be rotated/lifted to facilitate the removal of the roasting chamber 504 and the chaff collector 503.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A food roaster, comprising:
a base;
a motor and fan assembly positioned within the base;
a first heating element positioned within the base and in gaseous communication with the motor and fan assembly;
a roasting chamber removably attached to a top portion of the base;
a support tower mechanically affixed to the base; and
a filter to remove smoke expelled from the roasting chamber, the filter positioned within an upper portion of the support tower,
wherein the base, the motor and fan assembly, the heating element, the roasting chamber, and the filter are configured along a substantially unitary vertical axis.

2. The food roaster of claim 1, wherein the food roaster is adapted to roast coffee beans.

3. The food roaster of claim 1, wherein the roasting chamber comprises a handle.

4. The food roaster of claim 1, wherein the roasting chamber comprises an agitator in mechanical communication with a portion of the roasting chamber.

5. The food roaster of claim 1, wherein the roasting chamber comprises a thermometer configured to measure the temperature of a food or the temperature of the air in the roasting chamber.

6. The food roaster of claim 5, wherein the thermometer is a thermocouple.

7. The food roaster of claim 1, wherein the roasting chamber comprises ribs on the inside wall of the roasting chamber to assist in mixing a food and/or managing a flow of the food.

8. The food roaster of claim 1, wherein the roasting chamber comprises at least one tab configured to interact with at least one corresponding mechanical element on the base to removably attach the roasting chamber to the base.

9. The food roaster of claim 1, wherein the filter comprises a catalyst and a second heating element.

10. The food roaster of claim 4, further comprising a drive gear connected to the motor and the agitator.

11. The food roaster of claim 1, further comprising:
a pulley and drive belt connected to the motor; and
a reduction gear set connected to the pulley and drive belt.

12. The food roaster of claim 1, further comprising a reduction gear set connected to the motor.

13. The food roaster of claim 1, further comprising a chaff collector removably attached to the filter.

14. The food roaster of claim 13, wherein the chaff collector comprises an annular ring to collect chaff.

15. The food roaster of claim 13, further comprising a screen removably attached to the chaff collector.

16. The food roaster of claim 1, further comprising a control panel positioned on the support tower.

17. The food roaster of claim 1, wherein the support tower further comprises a lower portion and a hinge connecting the lower portion of the support tower to the upper portion of the support tower.

18. The food roaster of claim 1, wherein the base further comprises an air inlet.

19. The food roaster of claim 1, further comprising an electrical cord to provide electrical communication between the food roaster and an external power supply.

20. The food roaster of claim 1, wherein the upper portion of the support tower further comprising a locking tab configured to interact with a corresponding element on the roasting chamber to secure the upper portion of the support tower to the roasting chamber.

21. A method of roasting food, comprising:
providing raw food;
placing the raw food in a food roaster, comprising:
a base,
a motor and fan assembly positioned within the base,
a first heating element positioned within the base and in gaseous communication with the motor and fan assembly,
a roasting chamber removably attached to a top portion of the base,
a support tower mechanically affixed to the base, and
a filter to remove smoke expelled from the roasting chamber, the filter positioned within an upper portion of the support tower,
wherein the base, the motor and fan assembly, the heating element, the roasting chamber, and the filter are configured along a substantially unitary vertical axis, and
wherein the food is placed into the roasting chamber;
operating the food roaster to provide heated airflow into the roasting chamber and to allow exhaust from the roasting chamber to flow through the filter prior to exiting the food roaster; and
cooling the food.

22. The method of claim 21, wherein the food roaster further comprises an agitator in mechanical communication with a portion of the roasting chamber, and operating the food roaster further comprises operating the food roaster to stir and/or manage the flow of the food with the agitator.

23. The method of claim 21, wherein the filter further comprises a catalyst and a second heating element, and operating the food roaster further comprises heating the exhaust in the filter prior to allowing the exhaust to exit the food roaster.

24. The method of claim 21, further comprising allowing the food to be heated to from about 220° C. to about 250° C.

25. The method of claim 21, wherein the raw food comprises raw coffee beans.

26. A kit for roasting food, comprising:
a food roaster, comprising:
a base,
a motor and fan assembly positioned within the base,
a first heating element positioned within the base and in gaseous communication with the motor and fan assembly,
a roasting chamber removably attached to a top portion of the base,
a support tower mechanically affixed to the base, and
a filter to remove smoke expelled from the roasting chamber, the filter positioned within an upper portion of the support tower,
wherein the base, the motor and fan assembly, the heating element, the roasting chamber, and the filter are configured along a substantially unitary vertical axis; and instructions for using the food roaster to roast a raw food.

27. The kit of claim 26, wherein the raw food comprises raw coffee beans.
